(19) United States
(12) Patent Application Publication
(10) Pub. No.: US 2009/0086477 A1
(43) Pub. Date: Apr. 2, 2009

(54) PLANAR LIGHT SOURCE AND METHOD OF MANUFACTURING PLANAR LIGHT SOURCE

(75) Inventors: Koya NOBA, Tokorozawa-shi (JP); Takashi Watanabe, Fujiyoshida-shi (JP)

Correspondence Address: BRINKS HOFER GILSON & LIONE, P.O. BOX 10395, CHICAGO, IL, 60610, US

(73) Assignee: CITIZEN ELECTRONICS CO., LTD., Fujiyoshida-shi (JP)

(21) Appl. No.: 12/236,633

(22) Filed: Sep. 24, 2008

(30) Foreign Application Priority Data
Sep. 28, 2007 (JP) JP2007-255252

(51) Int. Cl. F21V 5/02

(52) U.S. Cl. 362/231

(57) ABSTRACT

A planar light source directly mixes three colors of light from light-emitting diodes into white light. The planar light source has a plurality of red (2r), green (2g) and blue (2b) light-emitting diodes mounted on a mount surface of a substrate to define a plurality of light source sets, each having mutually adjacent red, green and blue light-emitting diodes, and further has first and second prism sheets (PS1 and PS2) stacked to face the mount surface. The stacked prism sheets receive and mix three colors of light from the light-emitting diodes constituting each light source set and emit lights from the red, green and blue light-emitting diodes of each of the light source sets as white light.

### RELATED APPLICATIONS

This application claims priority under 35 U.S.C. §119 to Japanese Patent application No. JP2007-255252 filed on Sep. 28, 2007, the entire content of which is hereby incorporated by reference.

### TECHNICAL FIELD

The present invention relates to a planar light source that mixes incident light from a plurality of light-emitting diode (LED) light sources and emits mixed light. The present invention also relates to a method of manufacturing the planar light source.

### RELATED ART

Conventionally, a white light source is used as a backlight unit for a liquid crystal display apparatus or the like. The white light source mixes light emitted from a plurality of LED light sources to generate white light. In general, a planar light source is used as the white light source. In the planar light source, LEDs of three different colors are disposed along a side edge surface of a lightguide plate to make three colors of light, i.e. red (R), green (G), and blue (B), enter the lightguide plate through the side edge surface. The planar light source allows the three colors of light to travel through the lightguide plate while mixing together into white light and emits the mixed white light from a top surface of the lightguide plate. However, the lightguide plate used in this planar light source is large in size, which hinders reduction in size and thickness of the display apparatus. In addition, it is difficult for the whole light-emitting surface to have a uniform luminance distribution.

To improve the disadvantages of the above-described planar light source using a lightguide plate, there have been proposed various planar light sources using no lightguide plate. For example, Japanese Patent Application Publication No. 2006-228710 discloses a planar light source 70 as shown in FIGS. 14 and 15. The planar light source 70 has two prism sheets 70a and 70b and a light-emitting substrate 75 disposed underneath the prism sheets 70a and 70b. The light-emitting substrate 75 comprises a retaining substrate 74 having a plurality of LEDs 72 and a plurality of reflectors 73. The planar light source 70 irradiates a liquid crystal unit 80 disposed directly above it.

The LEDs 72 are arranged in a matrix. The reflectors 73 are each provided to partly cover one row of LEDs 72 associated therewith. Each reflector 73 has a first surface 73a facing the light-emitting surfaces of the LEDs 72 and a second surface 73b as a top surface thereof. The first surface 73a of one reflector 73 reflects light sideward after the light being emitted from each of the LEDs 72 toward the first surface 73a, and the second surface 73b of the next reflector 73 reflects the light upward after the light being reflected on the first surface 73a of the one reflector 73, causing the reflected light to enter the two stacked prism sheets 70a and 70b. The stacked prism sheets 70a and 70b direct the light upward (toward the liquid crystal unit 80).

The LEDs 72 are arranged to emit white light. Specifically, there are two types of white LEDs: one type in which an LED element having a specific emission wavelength is combined with a fluorescent substance to generate white light; and another type in which each LED has three LED elements, i.e. R, G and B, and mixes light emitted from the three LED elements to generate white light. Either type is usable. It is also possible to generate white light by comprising the LEDs 72 of three different types of LEDs, i.e. a red LED (hereinafter referred to as “R LED”), a green LED (hereinafter referred to as “G LED”), and a blue LED (hereinafter referred to as “B LED”) and arranging the first and second surfaces 73a and 73b of the reflectors 73 to reflect and mix the three colors of light.

Japanese Patent Application Publication No. 2005-117023, for example, discloses as one embodiment thereof a planar light source 90 as schematically shown in FIGS. 16 and 17. The planar light source 90 has a reflective substrate 91, a plurality of LEDs 92 mounted on the top of the reflective substrate 91, a diverter plate 93, a diffusing plate 94, a diffusing sheet 95, and a prism sheet 96.

The diverter plate 93 diffuses light emitted from the LEDs 92 and light reflected from the reflective substrate 91 and emits the diffused light upward. As shown in FIG. 17, the diverter plate 93 is provided with light-dimming dot patterns 93a. The dot patterns 93a are provided in one-to-one correspondence to the LEDs 92 mounted on the reflective substrate 91. Each dot pattern 93a is formed over a range that covers the light-emitting area of the corresponding LED 92. The light-dimming dot patterns 93a are formed by printing a reflective ink mixed with a light-shielding agent and a diffusing agent. The dot patterns 93a efficiently diffuse incident light by their light-diffusing properties and also reflect the incident light to prevent light from the LEDs 92, which are point light sources, from passing through the diverter plate 93 upward as it is and forming local high-luminance regions. As a result, the luminance over the entire light-exit surface of the planar light source becomes uniform.

The reflective substrate 91 has a plurality of LEDs 92 arranged in a matrix, for example. That is, R LEDs, G LEDs and B LEDs are arrayed regularly. The diverter plate 93 diffuses and mixes light from the R LEDs, G LEDs and B LEDs and exits the mixed light upward toward the diffusing plate 94.

The diffusing plate 94 further diffuses the mixed light from the diverter plate 93 to emit white light of uniform luminance. The diffusing sheet 95 and the prism sheet 96 direct the white light from the diffusing plate 94 to the directly upward direction to increase the surface luminance of the planar light source 90.

The above-described conventional planar light sources suffer, however, from the following problems. The planar light source 70 shown in FIGS. 14 and 15 has a plurality of reflectors 73 provided on the light-emitting substrate 75. Therefore, the structure is complicated, and it is difficult to reduce the thickness of the apparatus. In addition, the cost of the apparatus is unfavorably high.

The planar light source 90 shown in FIGS. 16 and 17 is superior in the uniformity of planar light emission but inferior in the light source utilization efficiency because a uniform luminance distribution is obtained by attenuating light emissions from the LEDs using the light-dimming dot patterns 93a. Further, the diffusing plate 94 and the diffusing sheet 95 need to be used to obtain white light by mixing R, G and B light. Consequently, the light source utilization efficiency is further degraded.

### SUMMARY OF THE INVENTION

The present invention has been made in view of the above-described problems with the conventional planar light sources. Accordingly, an object of the present invention is to provide a planar light source that is less costly and capable of being reduced in size and thickness and that has an increased light utilization efficiency. Another object of the present invention is to provide a method of manufacturing the planar light source.

The present invention provides a planar light source including a substrate having a mount surface and a plurality of red, green and blue LEDs mounted on the mount surface of the substrate. The LEDs are arranged to define a plurality of light source sets, each having mutually adjacent red, green and blue LEDs. The red, green and blue LEDs of each light source set are respectively disposed in corresponding quadrants of an X-Y coordinate system assumed over the light source set. The planar light source further includes a first prism sheet and a second prism sheet stacked over the first prism sheet. The first prism sheet is set to face the mount surface at a predetermined distance from the plurality of red, green and blue LEDs. The first and the second prism sheets each have mutually parallel elongated prisms on one surface thereof, an other surface thereof being a plane surface. The respective prisms of the first and the second prism sheets intersect each other in plan view of the first and the second prism sheets. The first and the second prism sheets are arranged so that the first prism sheet receives lights from the red, green and blue LEDs of the light source sets at a side of the first prism sheet, the side facing the light source set, and the second prism sheet emits the lights from a side of the second prism sheet, the side opposite to a side facing the first prism sheet with the lights emitted from positions corresponding to origins of the X-Y coordinate systems being mixed each other. The lights from the red, green and blue LEDs of each of the light source sets is a mixture of light from the red, green and blue LEDs constituting each light source set.

The planar light source can efficiently mix light from the red, green and blue LEDs and emit lights from the red, green and blue LEDs of each of the light source sets at and around a position corresponding to the origin of an X-Y coordinate system assumed over each light source set. Accordingly, it is possible to obtain a planar light source thinner and higher in light utilization efficiency than the above-described conventional apparatus.

Specifically, the plurality of red, green and blue LEDs may be arranged in a matrix, and mutually adjacent light source sets may overlap each other to have mutually shared LEDs. The light utilization efficiency can be further increased by overlapping mutually adjacent light source sets to have mutually shared light-emitting diodes as stated above.

More specifically, each light source set may have four light-emitting diodes that are one red LED, one green LED, one blue LED, and an additional LED selected from red, green and blue LED.

The plurality of red, green and blue LEDs may be arranged in a matrix in which columns having alternately disposed red and blue LEDs and columns having only green LEDs are alternately disposed, and the columns having alternately disposed red and blue LEDs are arranged to reverse the sequence of red and blue LEDs for each alternate column.

The plurality of red, green and blue LEDs may be arranged in a matrix in which columns having alternately disposed green and red LEDs and columns having alternately disposed blue and green LEDs are alternately disposed.

Of the four LEDs of each light source set, LEDs that are disposed in diagonally opposing quadrants may be in point symmetry with respect to the origin of the X-Y coordinate system, and LEDs that are disposed in mutually adjacent quadrants may be in line symmetry with respect to the X or Y axis of the X-Y coordinate system.

More specifically, the first and second prism sheets may have a prism apex angle of 90 degrees. The respective prisms of the first and second prism sheets may perpendicularly intersect each other in plan view of the first and second prism sheets. The angle between the X axis of the X-Y coordinate system and an imaginary line connecting each of the LEDs and the origin of the X-Y coordinate system may be approximately in the range of from 42 degrees to 45 degrees as seen in the X-Y plane of the X-Y coordinate system.

Each of the light-emitting diodes may be provided with a light-collecting member that maximizes the intensity of light from the LED in a predetermined direction.

Each of the LEDs may be provided at a light exit surface thereof with a lens that collects light from the LED within a predetermined divergence angle.

In making the above-described planar light source, light is made to enter the second prism sheet in a direction opposite to the exiting direction of the color-mixed light, which is derived from the red, green and blue LEDs constituting each of light source sets, and which is emitted from a position on a surface of the second prism sheet opposite to a surface thereof facing the first prism sheet, the position corresponding to the origin of the X-Y coordinate system. The red, green and blue LEDs constituting each of light source set may be respectively mounted at corresponding positions on the mount surface of the substrate that are irradiated with the above-described lights which are made to enter the second prism sheet at the positions corresponding to the origins of the X-Y coordinate systems in a direction opposite to a direction in which the lights from the red, green and blue LEDs of the light source sets are emitted and exit from the first prism sheet. Thus, with the planar light source of the present invention, the optimal positions of the LEDs can be determined easily, and hence the planar light source can be manufactured efficiently.

The first and second prism sheets may be disposed to emit the lights from the red, green and blue LEDs of each of the light source sets in a direction substantially perpendicular to the second prism sheet.

In the manufacture of the planar light source, the first and second prism sheets may be disposed to emit the lights from the red, green and blue LEDs of each of the light source sets in a direction substantially perpendicular to the second prism sheet.

The light made to enter the second prism sheet in a direction opposite to the exiting direction of the lights from the red, green and blue LEDs of each of the light source sets may be made to enter the second prism sheet substantially perpendicular thereto.

Embodiments of the present invention will be explained below with reference to the accompanying drawings.

### BRIEF DESCRIPTION OF THE DRAWINGS

FIG. 1 is an exploded perspective view of a planar light source according to a first embodiment of the present invention.

FIG. 2 is a fragmentary plan view of LEDs arranged on a light source substrate in FIG. 1, showing basic light source sets defined on the light source substrate.

FIG. 3 is a fragmentary plan view of LEDs arranged on the light source substrate in FIG. 1, showing all light source sets defined on the light source substrate.

FIG. 4 is a fragmentary plan view of LEDs arranged on the light source substrate in FIG. 1.

FIG. 5 is a sectional view taken along the line V-V in FIG. 4.

FIG. 6 is a diagram including plan and side views schematically showing the arrangement of two prism sheets PS 1 and PS2 and four light sources K1 to K4 of the light source substrate in FIG. 1.

FIG. 7 is a top view showing the relationship between the prism sheets and the four light sources K1 to K4 in FIG. 6.

FIG. 8 is an enlarged sectional view of a part of the upper prism sheet of the planar light source in FIG. 1.

FIG. 9 is an enlarged sectional view of a part of the lower prism sheet of the planar light source in FIG. 1.

FIG. 10 is a perspective view schematically showing an optical path along which incident light passes successively through the two prism sheets PS1 and PS2 of the planar light source in FIG. 1.

FIG. 11 is a table showing incident angles of light with respect to prisms of prism sheets made of materials having various refractive indices.

FIG. 12 is a fragmentary plan view of an LED arrangement different from that on the light source substrate in FIG. 1, showing a second embodiment of the present invention.

FIG. 13 is a fragmentary sectional view showing a main part of a planar light source according to a third embodiment of the present invention.

FIG. 14 is an exploded perspective view of a conventional planar light source.

FIG. 15 is a fragmentary enlarged side view of a light-emitting substrate shown in FIG. 14.

FIG. 16 is a sectional view of another conventional planar light source.

FIG. 17 is a plan view of a diverter plate of the planar light source shown in FIG. 16.

### DETAILED DESCRIPTION OF THE INVENTION

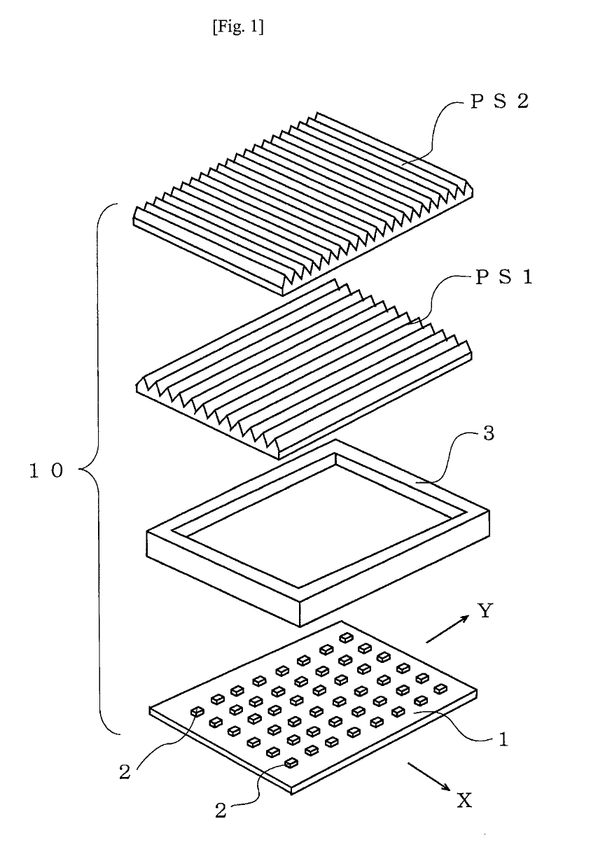

A planar light source 10 according to a first embodiment of the present invention has, as shown in FIGS. 1 to 5, a light source substrate 1 having a plurality of LEDs 2 arranged in a matrix. The planar light source 10 further has two prism sheets PS1 and PS2 disposed over the light source substrate 1 with a frame 3 interposed between the prism sheet PSI and the light source substrate 1. The prism sheets PS1 and PS2 each have a plurality of prisms provided on their top surfaces and are disposed with their respective prisms perpendicularly intersecting each other in plan view.

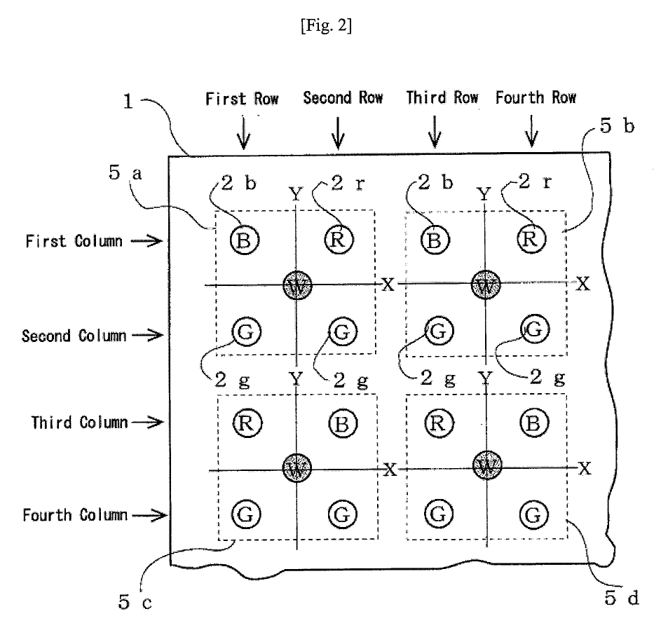

FIG. 2 is a fragmentary enlarged plan view of a part of the light source substrate 1. In the X-Y coordinate system of the light source substrate 1, B LEDs 2b and R LEDs 2r are alternately disposed in a first column parallel to the X axis at substantially equal intervals. In a second column, only G LEDs 2g are disposed at substantially equal intervals. In a third column, R LEDs 2r and B LEDs 2b are alternately disposed at substantially equal intervals. In a fourth column, only G LEDs 2g are disposed at substantially equal intervals.

In other words, in odd-numbered columns, B and R LEDs 2b and 2r are alternately disposed at substantially equal intervals, and the sequence of B and R LEDs 2b and 2r is reversed every odd-numbered column. In all even-numbered columns, only G LEDs 2g are disposed at substantially equal intervals.

Consequently, in a first row parallel to the Y axis, LEDs 2 are disposed in a repeat sequence of a B LED 2b, a G LED 2g, an R LED 2r and a G LED 2g. In a second row, LEDs 2 are disposed in a repeat sequence of an R LED 2r, a G LED 2g, a B LED 2b and a G LED 2g. That is, LEDs are disposed in each row in a repeat sequence in which a G LED 2g is put between B and R LEDs 2b and 2r, and the sequence of B and R LEDs 2b and 2r at odd numbered rows is reversed at even-numbered rows.

The plurality of LEDs mounted in a matrix on the light source substrate 1 are arranged to define light source sets as shown by reference symbols 5a, 5b, 5c and 5d in FIG. 2. Each light source set comprises one R LED 2r, one B LED 2b and two G LEDs 2g. The LEDs in each light source set are symmetrically disposed in the four quadrants, respectively, of an X-Y coordinate system assumed over the light source set. As will be stated later, each of the light source sets 5a, 5b, 5c and 5d is arranged to mix light from the R, G and B LEDs, which are disposed in the respective quadrants, at the origin of the X-Y coordinate system and to emit the mixed light as white light W directly upward.

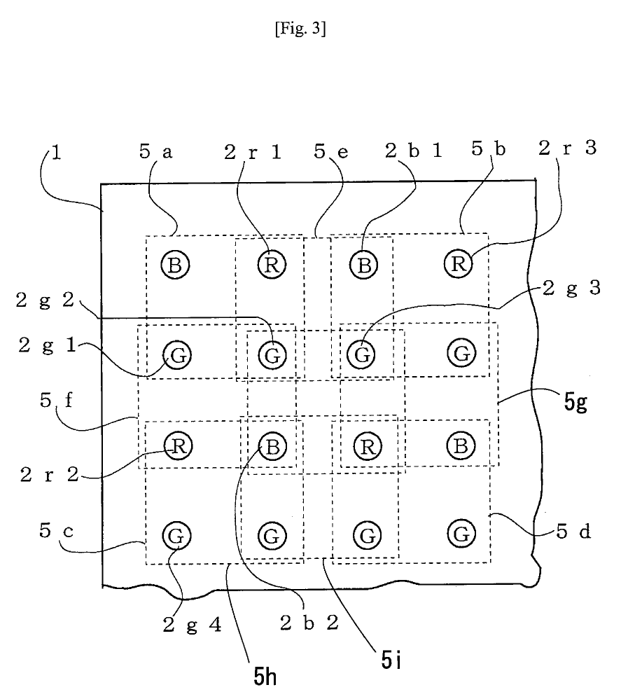

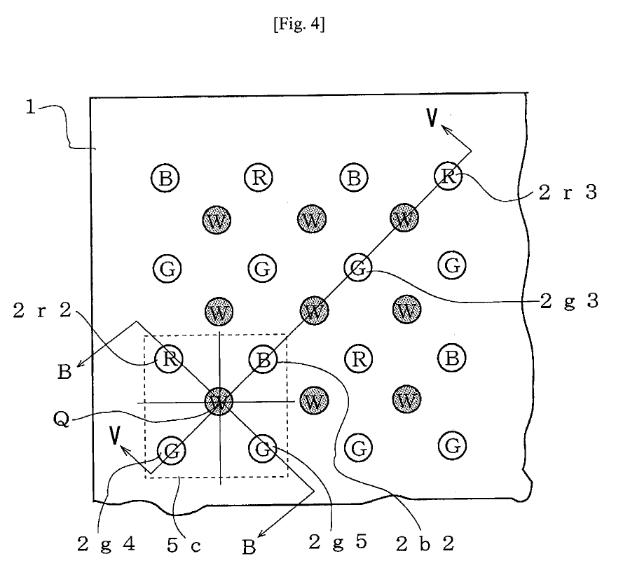

FIG. 3 shows the light source substrate 1 in the same way as in FIG. 2. FIG. 3, however, shows five other light source sets 5e, 5f, 5g, 5h and 5i, each comprising one R LED 2r, one B LED 2b and two G LEDs 2g. That is, a total of nine light source sets are defined on the light source substrate 1 in FIG. 3. Accordingly, this 4 by 4 LED matrix array emits nine beams of white light W as shown in FIG. 4.

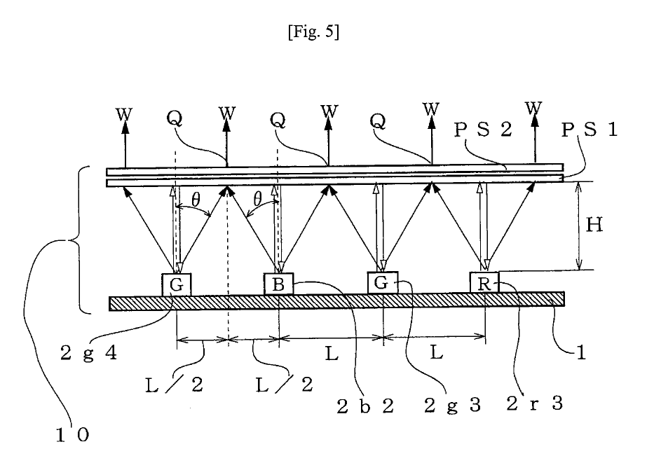

FIG. 5 is a sectional view taken along the line V-V in FIG. 4. In this section, a G LED 2g4, a B LED 2b2, a G LED 2g3 and an R LED 2r3 are mounted on the light source substrate 1 at equal intervals L, and a stack of two prism sheets PS1 and PS2 is disposed at a height H from the top of each LED 2. The height H from the top of each LED 2 to the bottom surface of the prism sheet PS1 is determined by the frame 3 (shown in FIG. 1) that supports the prism sheets PS1 and PS2.

Next, the operation of the planar light source 10 will be explained. The following explanation will be made with regard to the G LED 2g4 and the B LED 2b2, which are mutually adjacent LEDs, by way of example. The G LED 2g4 and the B LED 2b2 emit lights upward. Of the emitted lights, lights (shown by the black arrows) emitted in directions of an angle θ from the centers of the G LED 2g4 and B LED 2b2 are emitted directly upward as exiting light, which has been color-mixed by the intersecting prism sheets PS1 and PS2, from an exit point Q corresponding to a midpoint (position at L/2) between two LEDs, i.e. the G LED 2g4 and the B LED 2b2. With the arrangement shown in FIG. 5, the exiting light is a mixture of G light and B light and is therefore not white light W. However, mixing of light from the R LED 2r2 and light from the G LED 2g 5 takes place in the B-B section as shown in FIG. 4. Accordingly, white light W is emitted from the exit point Q as a mixture of three colors of lights from the G LEDs 2g4 and 2g5, B LED 2b2 and R LED 2r2, which constitute the light source set 5c. The same is the case with the other mutually adjacent LEDs. That is, white light W is emitted from the associated exit point Q by the same action as the above.

Lights emitted directly upward from the light-emitting surfaces of the G LED 2g4 and the B LED 2b2 are shown by the upward white arrows. The light repeats total reflections in the prism sheets PS I and PS2. Of the lights, lights that are returned toward the LEDs 2 and the top of the light source substrate 1 are shown by the downward white arrows. The returned lights are diffused and reflected at the substrate 1 and the LEDs 2 and eventually exit from the prism sheets PS1 and PS2. When the lights exit at an angle close to the angle θ, the exiting lights travel along a path close to the path of lights emitted at the angle θ. The greater parts of the lights are superimposed on one another to form white light. Therefore, the planar light source 10 can mix three colors of light from the R, G and B LEDs on the substrate 1 and emit white light efficiently as a whole.

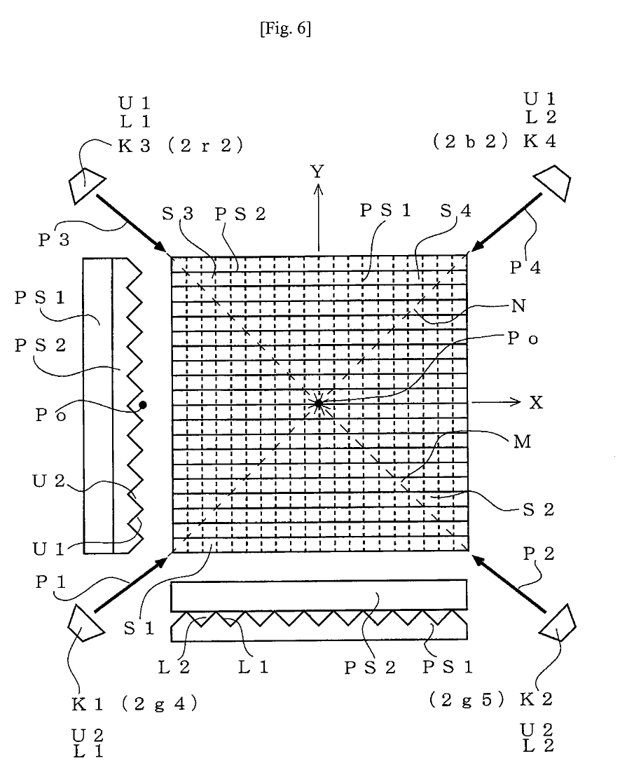

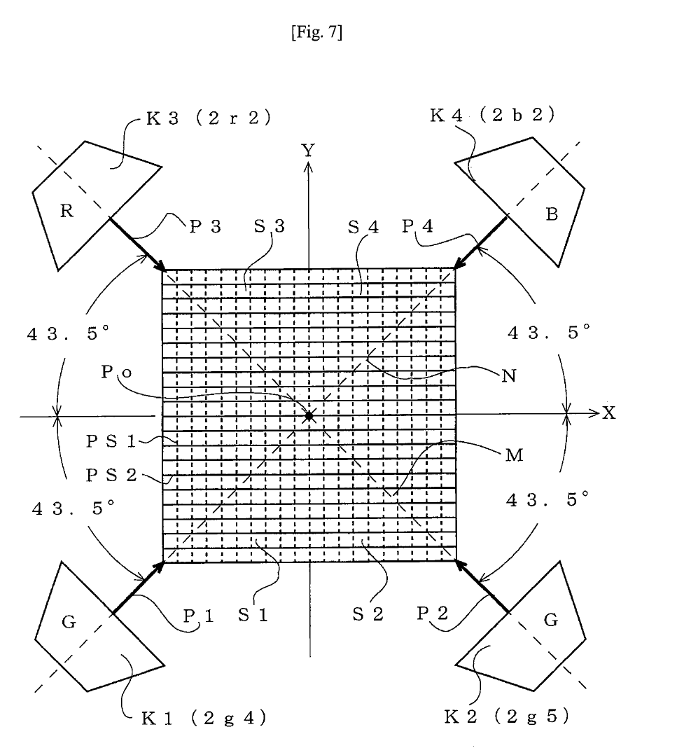

Next, let us explain the principle of light mixing by the stacked prism sheets PS1 and PS2 of the present invention with reference to FIGS. 6 to 10. FIG. 6 is a diagram including top and side views showing the arrangement of two prism sheets PS1 and PS2 and four light sources K1 to K4. FIG. 7 is a top view showing the relationship between the prism sheets PS1 and PS2 and the four light sources K1 to K4 in FIG. 6. FIGS. 6 and 7 illustrate a part of the planar light source 10 that includes the light source set 5c, which is shown in FIGS. 4 and 5, by way of example.

As shown in FIG. 6, the prism sheets PS1 and PS2 are stacked with their respective prism rows extending perpendicular to each other in plan view. In the prism sheet stack, the prism sheet PS1 is a lower prism sheet, and the prism sheet PS2 is an upper prism sheet. In this embodiment, the prism sheets PS1 and PS2 each have an upper surface serving as a prism surface and a lower surface as a plane surface, and the prism apex angle of each prism sheet is 90°. Although the prism sheets in this embodiment are stacked with their respective prism rows extending perpendicular to each other and the prism apex angle of each prism sheet is set at 90° for explanatory purposes, the arrangement of the present invention is not necessarily limited thereto. In FIG. 6, the solid lines parallel to the X axis in the top view of the prism sheets PS1 and PS2 show the peaks and valleys of the prism rows of the upper prism sheet PS2, and the dashed lines parallel to the Y axis show the peaks and valleys of the prism rows of the lower prism sheet PS1. The solid lines and the dashed lines intersect each other to form a grid pattern. The prism rows of the prism sheets PS1 and PS2 have a fine pitch of 1 μm to 100 μm.

The following is an explanation of the positional relationship between the two prism sheets PS2 and PS2 and the four light sources K1, K2, K3 and K4. As shown in FIG. 7, the light sources K1, K2, K3 and K4 are disposed in the four quadrants S1, S2, S3 and S4, respectively, of an X-Y coordinate system assumed over the light source set 5c. Incident light P1, P2, P3 and P4 emitted from the light sources K1, K2, K3 and K4, respectively, travel along near the lines N and M bisecting the included angles between the X— and Y axes on the two stacked prism sheets PS1 and PS2 and enter the prism sheet PS1 at and around the origin of the X-Y coordinate system. The incident lights P1, P2, P3 and P4 converge at a converging point Po located substantially on the top of the prism sheet PS2 at a position corresponding to the origin and exit from the prism sheet PS2.

As shown in FIG. 7, the light sources K1 and K4 are positioned in point symmetry with respect to the origin of the X-Y coordinate system and so are the light sources K2 and K3. The light sources K1 and K3 are positioned in line symmetry with respect to the X axis, and so are the light sources K2 and K4. The angle with respect to the X axis of each of the light sources K1 to K4 is the same. This angle is determined by the refractive index of the constituent material of the two prism sheets PS1 and PS2 and the prism apex angle. In this embodiment, an acrylic resin (PMMA) having a refractive index n of 1.49 is used as the material of the two prism sheets PS1 and PS2, and the prism apex angle is 90°. The light sources K1, K2, K3 and K4 are all positioned at the same angle of 43.5° from the X axis. This relationship between the prisms and the light sources allows the lights from the light sources to enter the stacked prism sheets and to exit directly upward, as will be stated below.

In FIG. 6, a Z axis is defined by the direction of exiting light from the stacked prism sheets PS1 and PS2 relative to the X-Y plane, i.e. a direction perpendicular to the X-Y plane. One prism inclined surface constituting each prism of the prism sheet PS1 is denoted by L1, and the other prism inclined surface by L2. One prism inclined surface constituting each prism of the prism sheet PS2 is denoted by U1, and the other prism inclined surface by U2. The light sources K1, K2, K3 and K4 each emit incident light entering the prism sheet PS1 at the same angle to the lower surface thereof (at an angle of 43.5° to the X axis in plan view).

Regarding each incident light, as shown in FIG. 6, the light source K1 emits incident light P1 that passes through the prism inclined surface L1 of the prism sheet PS1 and the prism inclined surface U2 of the prism sheet PS2 to become light exiting directly upward. Similarly, the light source K2 emits incident light P2 that passes through the prism inclined surface L2 of the prism sheet PS1 and the prism inclined surface U2 of the prism sheet PS2 to become directly upward exiting light. The light source K3 emits incident light P3 that passes through the prism inclined surface L1 of the prism sheet PS1 and the prism inclined surface U1 of the prism sheet PS2 to become directly upward exiting light. The light source K4 emits incident light P4 that passes through the prism inclined surface L2 of the prism sheet PS1 and the prism inclined surface U1 of the prism sheet PS2 to become directly upward exiting light.

Incident light with a wide area from each light source exits refractively through the inclined surfaces of a large number of prisms provided on the two prism sheets PS1 and PS2. In this regard, the prism rows are arranged at a fine pitch of 1 μm to 100 μm, as has been stated above. Therefore, the light P1, P2, P3 and P4 as emitted from the two stacked prism sheets PS1 and PS2 are not visually recognized as discrete exiting light but as mixed single exiting light.

To obtain an optical path through a prism, the following method is generally used: In a case where incident light is made to enter a single prism sheet from the lower side thereof to obtain exiting light emitted directly upward from the prism sheet, lights are traced backward to obtain the optical path. For example, in the case of the upper prism sheet PS2 shown in FIG. 8, color-mixed white light Pw needs to be emitted directly upward as exiting light. Therefore, exiting light from each light source is made to enter the prism sheet PS2, which is made of an acrylic resin, from directly above the prism sheet PS2 to trace the lights backward. At this time, the incident light travels through the prism sheet PS2 after being given a predetermined angle of refraction according to Snell's law at the interface between the air and the acrylic resin due to the difference in refractive index therebetween. When exiting into the air from the lower surface of the prism sheet PS2, the light is also given a predetermined refraction angle according to Snell's law at the interface between the acrylic resin and the air.

To use the prism sheet PS2 in an actual planar light source, each light source makes incident light enter the prism sheet PS2 through the lower surface thereof at an angle equal to the angle of light exiting into the air from the prism sheet lower surface in the above-described backward light tracing. By so doing, the incident light travels through the prism sheet PS2 at a predetermined angle of refraction similar to the refraction angle confirmed by the above-described method. Therefore, it is possible to obtain exiting light emitted directly upward from the upper surface of the prism sheet PS2.

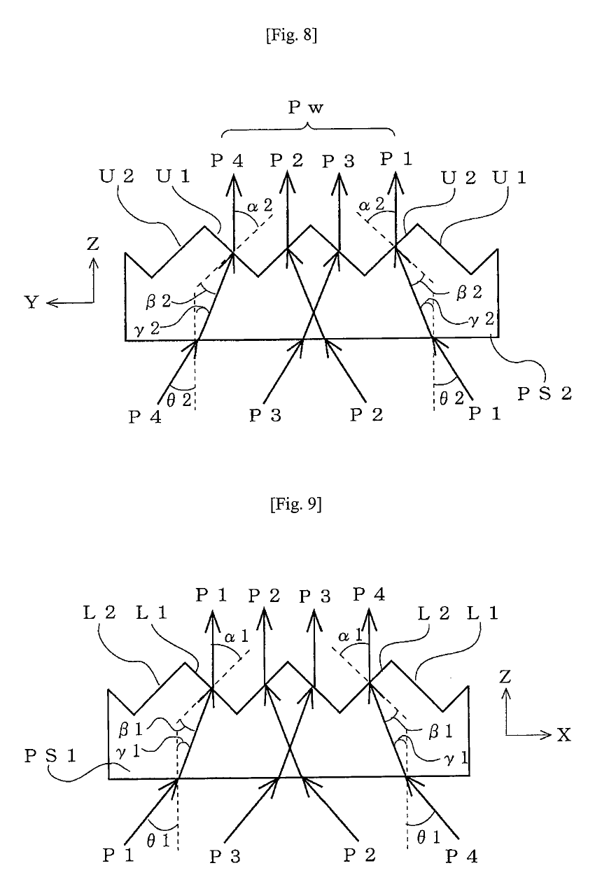

Next, the actual optical path of incident light from each light source applied to the two stacked prism sheets PS1 and PS2 will be explained with reference to FIGS. 8 and 9. In the case of the upper prism sheet PS2 shown in FIG. 8, the Y-Z plane is shown. The greater parts of incident light P1 and P2 from the light sources K1 and K2, which are shown in FIG. 6, pass through the left prism inclined surfaces U2 of the prism sheet PS2 and exit directly upward. Similarly, the greater parts of incident light P3 and P4 from the light sources K3 and K4 pass through the right prism inclined surfaces U1 of the prism sheet PS2 and exit directly upward. Thus, the incident direction in which the incident light P1 and P2 enter the prism sheet PS2 through the lower surface thereof is leftward oblique as seen in FIG. 8, and the incident direction of the incident light P3 and P4 is rightward oblique. That is, the incident direction of the incident light P1 and P2 and that of the incident light P3 and P4 are opposite to each other. However, all the angles of the incident light P1 to P4 to the lower surface of the prism sheet PS2 are the same, and so are the angles of the incident light P1 to P4 to the prism inclined surfaces.

That is, the angles θ2 and γ2 of all incident light P1, P2, P3 and P4 with respect to the normal (shown by the dashed lines) to the interface of the lower surface of the prism sheet PS2 are the same, respectively, and the angles β2 and α2 of all exiting light P1, P2, P3 and P4 with respect to the normal (shown by the dashed lines) to the prism inclined surfaces of the prism sheet PS2 are the same, respectively. These angles are as follows: α2=45.0°; β2=28.3°; γ2=16.7°; and θ2=25.3°.

In the case of the lower prism sheet PS1 shown in FIG. 9, the X-Z plane is shown. The angles θ1 and γ1 of all incident light P1, P2, P3 and P4 with respect to the normal (shown by the dashed lines) to the interface of the lower surface of the prism sheet PS1 are the same, respectively, and the angles β1 and α1 of all exiting light P1, P2, P3 and P4 with respect to the normal (shown by the dashed lines) to the prism inclined surfaces of the prism sheet PS1 are the same, respectively. These angles are as follows: α1=50.3°; β1=31.1°; γ1=24.6°; and θ1=38.4°. Although the exiting light P1 to P4 from the prism sheet PS1 in FIG. 9 are shown to be emitted directly upward for the sake of drawing, it should be noted that the exiting light P1 to P4 are inclined in the Y-Z plane as shown in FIG. 8.

In FIGS. 8 and 9, the incident light P1 and P2 (P3 and P4) are shown striking different prism inclined surfaces for the sake of easy understanding. In actuality, the incident light P1 and P2 (P3 and P4) strike not only different prism inclined surfaces but also the same prism inclined surfaces simultaneously and are mixed together.

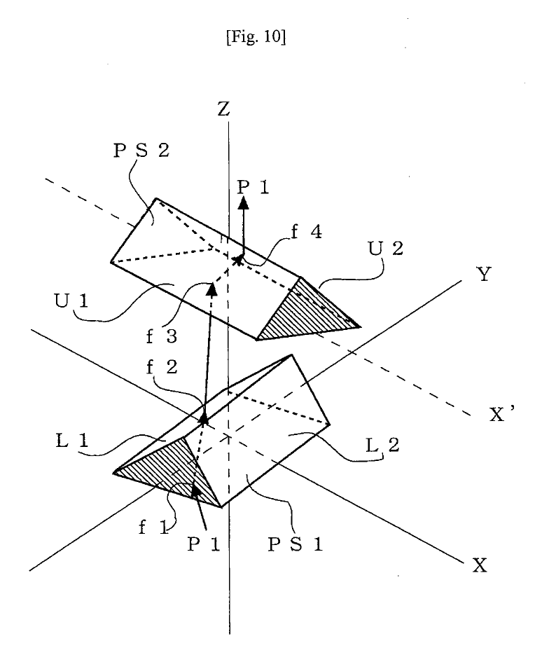

FIG. 10 is a perspective view schematically showing an optical path along which incident light passes successively through the two prism sheets PS1 and PS2. In FIG. 10, only incident light P1 is shown as a representative example.

As shown in FIG. 10, when incident light P1 enters the lower prism sheet PS1 from a point f1 on the lower surface thereof at an angle of 43.5° from the X axis in the X-Y plane relative to the prism rows and at an angle (θ1) of 38.4° with respect to the normal to the interface of the prism sheet lower surface as seen in the Z-X plane, the light exits into the air from a point f2 on the prism inclined surface L1 after being refracted in the prism sheet PS1. The exiting light P1 enters the upper prism sheet PS2 from a point f3 on the lower surface thereof at an angle (θ2) of 25.3° with respect to the normal to the interface of the prism sheet lower surface as seen in the Y-Z plane. The light exits into the air directly upward from a point f4 on the prism inclined surface U2 after being refracted in the prism sheet PS2. Similarly, incident light P2, P3 and P4 (not shown in FIG. 10) travel and exit along the optical paths shown in FIGS. 8 and 9. It should be noted that in FIG. 10 the two prism sheets PS1 and PS2 are shown to be slightly away from each other for the sake of easy understanding. In addition, an X′ axis parallel to the X axis is provided as a hypothetical axis for easy understanding of the position of the prism sheet PS2 relative to the prism sheet PS1.

Thus, the planar light source of the present invention allows lights from the light sources K1, K2, K3 and K4 to travel under the same conditions all the way from the entrance into the stacked prism sheets until the directly upward exiting from the prism sheets, thereby mixing the lights to obtain white light as exiting light.

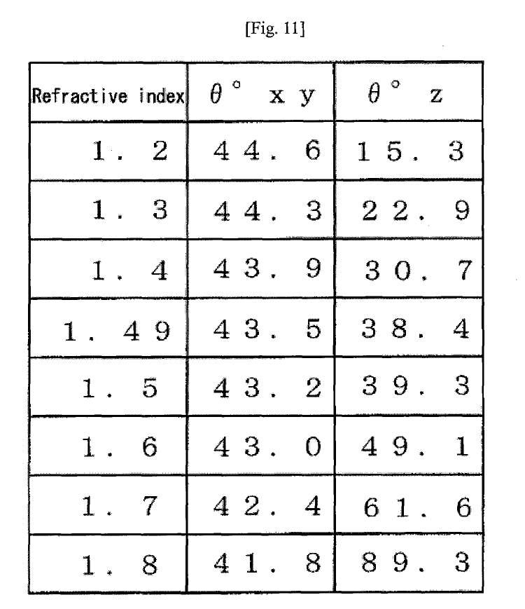

FIG. 11 is a table showing incident angles of light with respect to the prisms of two prism sheets made of materials having various refractive indices. More specifically, prism sheets having a prism apex angle of 90° were made of materials having various refractive indices, and each pair of these prism sheets were stacked with their respective prisms extending perpendicular to each other as two prism sheets PS1 and PS2. Under these conditions, we obtained, for each pair of prism sheets having a particular refractive index, an angle θ°xy that light from the light sources K1, K2, K3 and K4 makes with the X axis as seen in the X-Y plane when passing through the converging point Po and an angle θ°z that the light makes with the Z axis as seen in the X-Z plane when passing through the converging point Po. As will be clear from FIG. 11, for prism sheets made of materials having a refractive index n of 1.2 to about 1.8, the θ°xy is approximately in the range of from 45° to 42°.

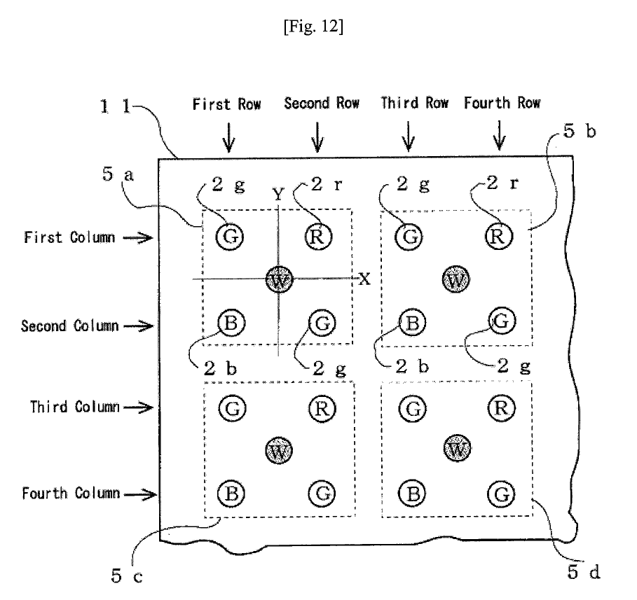

Next, a light source substrate in a second embodiment of the present invention will be explained with reference to FIG. 12. FIG. 12 is a fragmentary enlarged plan view of a part of a light source substrate 11, showing light sources R, G and B LEDs arranged in a matrix in the same way as the light source substrate 1 shown in FIG. 2. The light source substrate 11 differs from the light source substrate 1 shown in FIG. 2 in the arrangement of R, G and B LEDs. That is, on the light source substrate 11, G LEDs 2g and R LEDs 2r are alternately disposed in a first column parallel to the X axis at substantially equal intervals. In a second column, B LEDs 2b and G LEDs 2g are alternately disposed at substantially equal intervals. In a third column, G LEDs 2g and R LEDs 2r are alternately disposed at substantially equal intervals. In a fourth column, B LEDs 2b and G LEDs 2g are alternately disposed at substantially equal intervals.

In other words, in odd-numbered columns, G and R LEDs 2g and 2r are alternately disposed at substantially equal intervals. In even-numbered columns, B and G LEDs 2b and 2g are alternately disposed at substantially equal intervals. Consequently, in odd-numbered rows, i.e. first and third rows, parallel to the Y axis, G and B LEDs 2g and 2b are alternately disposed, and in even-numbered rows, i.e. second and fourth rows, R and G LEDs 2r and 2g are alternately disposed.

With the above-described LED array, a plurality of light source sets 5a to 5d are formed on the light source substrate 11 in the same way as the light source substrate 1. That is, the LEDs mounted in a matrix on the light source substrate 11 are arranged to define light source sets 5a, 5b, 5c and 5d, each comprising three colors of LEDs, i.e. one R LED, one B LED and two G LEDs. The LEDs in each light source set are disposed in the four quadrants, respectively, of an X-Y coordinate system assumed over the light source set. Each light source set 5 is arranged to mix light from the R, G and B LEDs, which are disposed in the respective quadrants, at the origin of the X-Y coordinate system and to emit the mixed light directly upward as white light W. Further, light source sets (not shown) similar to the light source sets 5e to 5i on the light source substrate 1 shown in FIG. 3 are formed on the light source substrate 11.

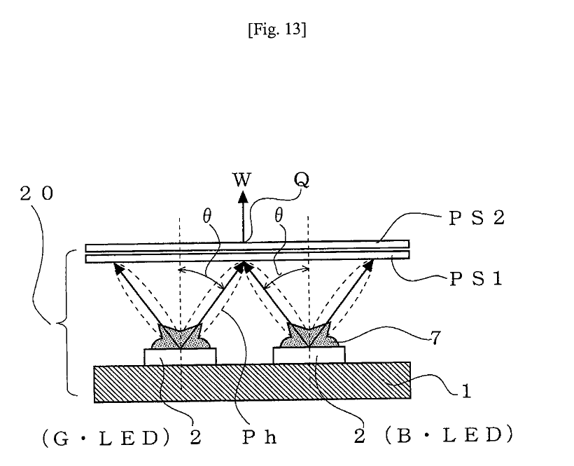

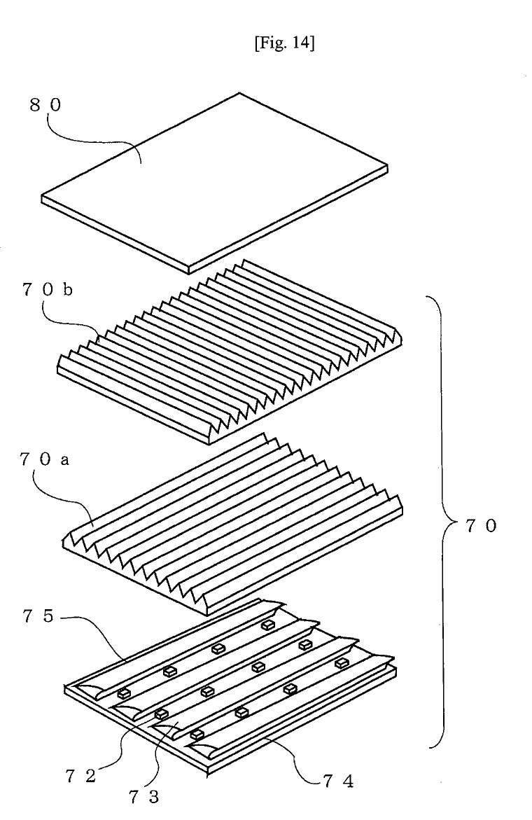

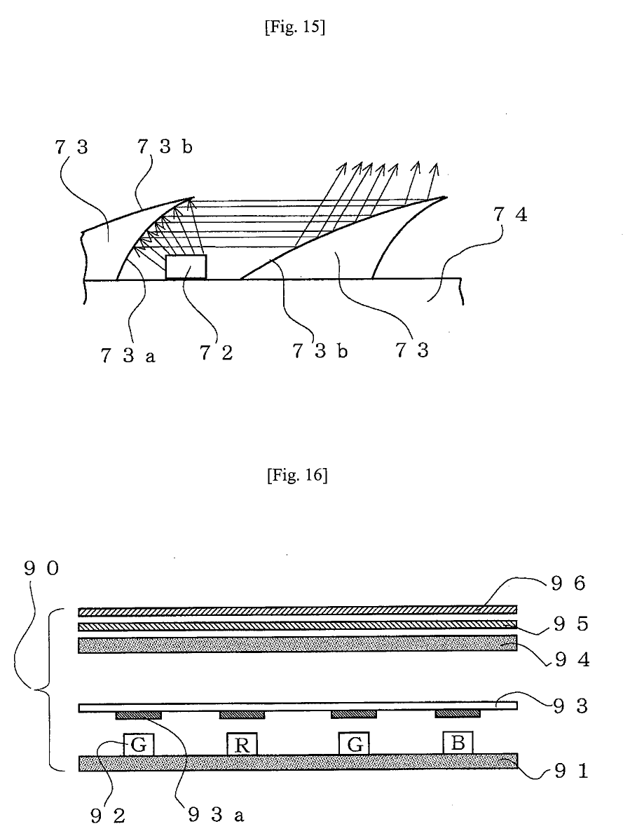

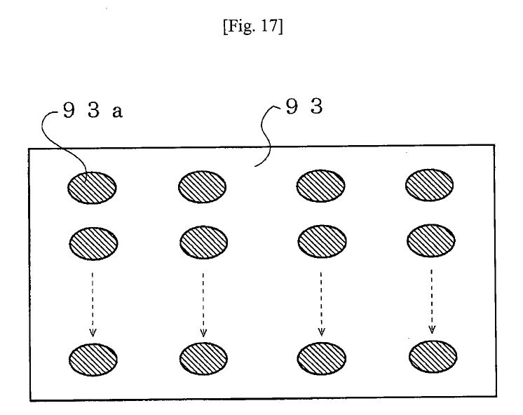

FIG. 13 is a fragmentary sectional view of a part of a planar light source 20 according to a third embodiment of the present invention. The basic structure of the planar light source 20 is the same as that of the planar light source 10 according to the first embodiment shown in FIG. 5. Therefore, the same constituent elements of the planar light source 20 as those of the planar light source 10 are denoted by the same reference numerals as used in FIG. 5, and a redundant description thereof is omitted herein.

Unlike the planar light source 10 shown in FIG. 5, the planar light source 20 has a lens 7 provided for each LED 2 as a light-collecting member. The lens 7 enables light emitted from the LED 2 to have the highest radiant intensity in directions of a predetermined angle 0 from the center axis as shown by exiting light Ph. With such light distribution characteristics, the greater part of light emitted from the LED 2 can be utilized as effective light. Thus, an efficient planar light source can be obtained.

In the planar light source according to the present invention, as has been stated above, a plurality of light source sets mounted on a light source substrate are defined as a plurality of light source sets, each comprising R, G and B LEDs, and stacked prism sheets directly mix together light from the light sources in each set and emit the mixed light as white light. In this regard, even more uniform white light can be obtained by disposing a diffusing plate at the upper side of the stacked prism sheets.

Thus, the present invention can provide a thin planar light source by using a light source substrate constituting light source sets and stacked prism sheets. The present invention has a wide application range and is usable not only as backlight units for liquid crystal display apparatus but also as general planar light sources and emissive display panels.

1. A planar light source comprising:
a substrate having a mount surface;
a plurality of red, green and blue light-emitting diodes mounted on the mount surface of the substrate, the light-emitting diodes being arranged to define a plurality of light source sets, each having mutually adjacent red, green and blue light-emitting diodes, the red, green and blue light-emitting diodes of each light source set being respectively disposed in corresponding quadrants of an X-Y coordinate system assumed over the each light source set; and
a first prism sheet and a second prism sheet stacked over the first prism sheet, the first prism sheet being set to face the mount surface at a predetermined distance from the plurality of red, green and blue light-emitting diodes, the first prism sheet and the second prism sheet each having mutually parallel elongated prisms on one surface thereof, an other surface thereof being a plane surface, the prisms of the first prism sheet and the prisms of the second prism sheet intersecting each other in plan view of the first and second prism sheets, the first and the second prism sheets being arranged so that the first prism sheet receives lights from the red, green and blue light-emitting diodes of the light source sets at a side of the first prism sheet, the side facing the light source sets, and the second prism sheet emits the lights from a side of the second prism sheet, the side opposite to a side facing the first prism sheet with the lights emitted from positions corresponding to origins of the X-Y coordinate systems being mixed each other.

2. The planar light source of claim 1, wherein the plurality of red, green and blue light-emitting diodes are arranged in a matrix, and mutually adjacent ones of the light source sets overlap each other to have mutually shared light-emitting diodes.

3. The planar light source of claim 1, wherein the each light source set has four light-emitting diodes that are one red light-emitting diode, one green light-emitting diode, one blue light-emitting diode, and an additional light-emitting diode selected from red, green and blue light-emitting diodes.

4. The planar light source of claim 2, wherein the each light source set has four light-emitting diodes that are one red light-emitting diode, one green light-emitting diode, one blue light-emitting diode, and an additional light-emitting diode selected from red, green and blue light-emitting diodes.

5. The planar light source of claim 3, wherein the plurality of red, green and blue light-emitting diodes are arranged in a matrix in which columns having alternately disposed red and blue light-emitting diodes and columns having only green light-emitting diodes are alternately disposed, the columns having alternately disposed red and blue light-emitting diodes being arranged to reverse a sequence of red and blue light-emitting diodes for each alternate column.

6. The planar light source of claim 4, wherein the plurality of red, green and blue light-emitting diodes are arranged in a matrix in which columns having alternately disposed red and blue light-emitting diodes and columns having only green light-emitting diodes are alternately disposed, the columns having alternately disposed red and blue light-emitting diodes being arranged to reverse a sequence of red and blue light-emitting diodes for each alternate column.

7. The planar light source of claim 3, wherein the plurality of red, green and blue light-emitting diodes are arranged in a matrix in which columns having alternately disposed green and red light-emitting diodes and columns having alternately disposed blue and green light-emitting diodes are alternately disposed.

8. The planar light source of claim 4, wherein the plurality of red, green and blue light-emitting diodes are arranged in a matrix in which columns having alternately disposed green and red light-emitting diodes and columns having alternately disposed blue and green light-emitting diodes are alternately disposed.

9. The planar light source of claim 3, wherein, of the four light-emitting diodes of the each light source set, the light-emitting diodes that are disposed in diagonally opposing quadrants are in point symmetry with respect to the origin of the X-Y coordinate system, and the light-emitting diodes that are disposed in mutually adjacent quadrants are in line symmetry with respect to either one of X and Y axes of the X-Y coordinate system.

10. The planar light source of claim 4, wherein, of the four light-emitting diodes of the each light source set, the light-emitting diodes that are disposed in diagonally opposing quadrants are in point symmetry with respect to the origin of the X-Y coordinate system, and the light-emitting diodes that are disposed in mutually adjacent quadrants are in line symmetry with respect to either one of X and Y axes of the X-Y coordinate system.

11. The planar light source of claim 3, wherein the first prism sheet and the second prism sheet have a prism apex angle of 90 degrees, the prisms of the first prism sheet and the prisms of the second prism sheet perpendicularly intersecting each other in plan view of the first prism sheet and the second prism sheet, and an angle between an X axis of the X-Y coordinate system and an imaginary line connecting each of the light-emitting diodes and the origin of the X-Y coordinate system is approximately in a range of from 42 degrees to 45 degrees as seen in an X-Y plane of the X-Y coordinate system.

12. The planar light source of claim 4, wherein the first prism sheet and the second prism sheet have a prism apex angle of 90 degrees, the prisms of the first prism sheet and the prisms of the second prism sheet perpendicularly intersecting each other in plan view of the first prism sheet and the second prism sheet, and an angle between an X axis of the X-Y coordinate system and an imaginary line connecting each of the light-emitting diodes and the origin of the X-Y coordinate system is approximately in a range of from 42 degrees to 45 degrees as seen in an X-Y plane of the X-Y coordinate system.

13. The planar light source of claim 1, wherein each of the light-emitting diodes is provided with a light-collecting member that maximizes an intensity of light from the each of the light-emitting diodes in predetermined directions.

14. The planar light source of claim 1, wherein each of the light-emitting diodes is provided at a light exit surface thereof with a lens that collects light from the each of the light-emitting diodes within predetermined divergent angles.

15. The planar light source of claim 1, wherein the red, green and blue light-emitting diodes constituting each of the light source sets are respectively mounted at corresponding positions on the mount surface of the substrate that are irradiated with lights which are made to enter the second prism sheet at the positions corresponding to the origins of the X-Y coordinate systems in a direction opposite to a direction in which the lights from the red, green and blue light-emitting diodes of the light source sets are emitted and exit from the first prism sheet.

16. The planar light source of claim 1, wherein the first prism sheet and the second prism sheet are disposed to direct the lights from the red, green and blue light-emitting diodes of each of the light source sets in a direction substantially perpendicular to the second prism sheet.

17. The planar light source of claim 15, wherein the first prism sheet and the second prism sheet are disposed to direct the lights from the red, green and blue light-emitting diodes of each of the light source sets in a direction substantially perpendicular to the second prism sheet.

18. The planar light source of claim 15, wherein the light made to enter the second prism sheet is made to enter the second prism sheet substantially perpendicular thereto.
